(19) United States
(12) Patent Application Publication
(10) Pub. No.: US 2016/0205945 A1
(43) Pub. Date: Jul. 21, 2016

(54) BACILLUS THURINGIENSIS SUBSP. KURSTAKI AND BACILLUS THURINGIENSIS SUBSP. AIZAWAI COMBINATION FORMULATIONS

(71) Applicant: Valent BioSciences Corporation, Libertyville, IL (US)

(72) Inventors: Bala N. Devisetty, Buffalo Grove, IL (US); Samun Dahod, Bokeelia, FL (US); Frederick Marmor, Litchfield, AZ (US)

(21) Appl. No.: 14/997,472

(22) Filed: Jan. 15, 2016

Related U.S. Application Data
(60) Provisional application No. 62/104,157, filed on Jan. 16, 2015.

(51) Int. Cl. A01N 63/02; A01N 43/56

(52) U.S. Cl. CPC A01N 63/02; A01N 43/56

(57) ABSTRACT

The present invention generally relates an agricultural formulation comprising a high potency Bacillus thuringiensis subsp. kurstaki strain and a Bacillus thuringiensis subsp. aizawai strain, wherein the weight ratio of Bacillus thuringiensis subsp. kurstaki to Bacillus thuringiensis subsp. aizawai is from about 20:80 to 80:20. The present invention is also directed to methods of manufacturing the formulation of the present invention and using the same to effectively control crop pests.

### FIELD OF THE INVENTION

The present invention generally relates to an agricultural formulation comprising a high potency Bacillus thuringiensis subsp. kurstaki strain and a Bacillus thuringiensis subsp. aizawai strain, wherein the weight ratio of Bacillus thuringiensis subsp. kurstaki to Bacillus thuringiensis subsp. aizawai is from about 20:80 to about 80:20. The present invention is also directed to methods of using the formulations of the present invention to control crop pests and methods of making the present formulation.

### BACKGROUND OF THE INVENTION

Bacillus thuringiensis is a natural soil bacterium. Many Bacillus thuringiensis strains produce crystal proteins during sporulation called δ-endotoxins which can be used as a biological insecticide. Bacillus thuringiensis, subspecies kurstaki, and subspecies aizawai, produce crystals which upon ingestion paralyze the digestive systems of some Lepidopteran larvae within minutes. The larvae eventually die of starvation.

One advantage of using Bacillus thuringiensis subsp. kurstaki and aizawai is that they are safe for humans and the environment. Because Bacillus thuringiensis subsp. kurstaki and aizawai are target specific insecticides, they do not harm humans or non-target insects. Bacillus thuringiensis subsp. kurstaki and aizawai can also be used on crops right before harvest. This provides organic growers, who have few options for pest control, a safe and effective way to manage insect infestations that could ultimately ruin an entire crop.

Recently, a high potency strain of Bacillus thuringiensis subsp. kurstaki was discovered. This strain, 2546, provides at least double the amount of 6-endotoxins than other strains.

Lepidoptera is an order of insects which includes moths or butterflies. It is estimated that there are over 174,000 Lepidopteran species, included in an estimated 126 families. Lepidopteran species undergo a complete metamorphosis during their life cycle. Adults mate and lay eggs. The larvae that emerge from the eggs have a cylindrical body and chewing mouth parts. Larvae undergo several growth stages called instars until they reach their terminal instar and then pupate. Lepidoptera then emerge as adult butterflies or moths.

While some Lepidoptera species are generally considered beneficial organisms due to their aesthetic appeal, many species cause devastating damage to crops. Possibly as a result of failing to rotate chemical control procedures, there have been reports of Lepidoptera species developing resistance to commonly used insecticides. Accordingly, there is a need for safe and effective formulations for Lepidopteran pest control. These formulations should be easy to apply, have increased efficacy, reduced risk of increasing resistance rates, and be cost effective.

### SUMMARY OF THE INVENTION

In one aspect, the present invention is directed to agricultural formulations comprising from about 10 to about 40% w/w of Bacillus thuringiensis fermentation solids, spores and insecticidal toxins, and from about 60 to about 90% w/w of a diluent, wherein the fermentation solids, spores and insecticidal toxins are derived from a high potency Bacillus thuringiensis subsp. kurstaki strain and a Bacillus thuringiensis subsp. aizawai strain, and the weight ratio of Bacillus thuringiensis subsp. kurstaki fermentation solids, spores and insecticidal toxins to Bacillus thuringiensis subsp. aizawai fermentation solids, spores and insecticidal toxins is from about 20:80 to about 80:20.

In another aspect, the present invention is directed to methods of using the formulations of the present invention to control crop pests.

In yet another aspect, the present invention is directed to methods of making the formulations of the present invention.

### DETAILED DESCRIPTION OF THE INVENTION

Applicant unexpectedly created a new formulation for effective crop plant pest control. The use of a high potency strain is critical to the success of the formulations because if a low potency Bacillus thuringiensis subsp. kurstaki strain is used, the toxins of Bacillus thuringiensis subsp. kurstaki are too diluted after being combined with Bacillus thuringiensis subsp. aizawai to achieve the desired high kill rates of target crop plant pests.

Further, Applicant's formulations include a diluent and a specific range of total Bacillus thuringiensis which provides superior efficacy rates. Applicant did not expect that the formulations of the present invention would provide excellent kill rates of numerous crop plant species. The formulations of the present invention are also effective against pests which have developed resistance to a commonly used insecticide such as chlorantraniliprole.

Applicant's formulations provide protection from a wider range of crop pests than can be obtained using either Bacillus thuringiensis strain alone. Bacillus thuringiensis subsp. kurstaki and Bacillus thuringiensis subsp. aizawai each contain different toxin profiles. By novel methods of combining toxins and spores of both the strains into a single product, Applicant was able to achieve high efficacy on a broader range of Lepidopteran larvae.

Another advantage of the present invention is that the combination of Bacillus thuringiensis subsp. aizawai and Bacillus thuringiensis subsp. kurstaki aligns with Integrated Pest Management (IPM) principles. By combining different toxins, and a wide range of toxins, the ability of the insects to dominantly express mutations which overcome all of the toxins is very unlikely.

Yet another advantage of the present invention is that it requires less total Bacillus thuringiensis to be applied to the plants. The grower does not have a need to switch to alternate biological synthetic pesticides thus resulting in significant cost saving to the grower.

A further advantage of formulations of the present invention is that Bacillus thuringiensis subsp. kurstaki and Bacillus thuringiensis subsp. aizawai are target specific. This means that humans and other, non-target organisms, such as natural predators of the target pests, will not be harmed by the methods of the present invention.

In one embodiment, the present invention is directed to agricultural formulations comprising from about 10 to about 40% w/w of Bacillus thuringiensis fermentation solids, spores and insecticidal toxins, and from about 60 to about 90% w/w of a diluent, wherein the fermentation solids, spores and insecticidal toxins are derived from a high potency Bacillus thuringiensis subsp. kurstaki strain and a Bacillus thuringiensis subsp. aizawai strain, and the weight ratio of Bacillus thuringiensis subsp. kurstaki fermentation solids, spores and insecticidal toxins to Bacillus thuringiensis subsp. aizawai fermentation solids, spores and insecticidal toxins is from about 20:80 to about 80:20.

In a preferred embodiment, the high potency Bacillus thuringiensis subsp. kurstaki strain is selected from the group consisting of ABTS-351, VBTS-2528 and VBTS-2546. In a more preferred embodiment, the high potency Bacillus thuringiensis subsp. kurstaki strain is VBTS-2546.

As used herein, a “high potency” Bacillus thuringiensis subsp. kurstaki strain refers to a strain with a harvest beer potency of at least 7500 IU/mg or concentrated slurry potency of at least 28,000 IU/mg. Percent solids in the fermentation liquids containing 6-endotoxins (also known as Cry toxins) spores, synergistic soluble metabolites and soluble proteins may range from about 7% to 20% wt/wt depending upon how the fermentation harvest is recovered or concentrated.

In another preferred embodiment, the weight ratio of Bacillus thuringiensis subsp. kurstaki fermentation solids, spores and insecticidal toxins to Bacillus thuringiensis subsp. aizawai fermentation solids, spores and insecticidal toxins is from about 30:70 to about 70:30. In a more preferred embodiment, the ratio of Bacillus thuringiensis subsp. kurstaki to Bacillus thuringiensis subsp. aizawai is from about 55:45 to about 65:35. In a most preferred embodiment, the ratio is about 60:40.

In another embodiment, the formulations contain multiple δ-endotoxins Cry1Aa, Cry1Ab, Cry1Ac, Cry1C, Cry1D, and Cry2Aa.

In yet another embodiment, the total amount of Bacillus thuringiensis fermentation solids, spores and insecticidal toxins in the formulation is from about 15 to about 35% w/w. In a preferred embodiment, the total amount of Bacillus thuringiensis fermentation solids, spores and insecticidal toxins in the formulation is from about 23 to about 29% w/w.

In another embodiment, the formulations contain from about 65 to about 80% w/w of the diluent. In a preferred embodiment, the formulations contain from about 63 to about 70% w/w diluent.

Suitable diluents include corn oil, soybean oil, cottonseed oil, canola oil, palm oil, methylated seed oils, paraffinic oil, isoparaffins, mixtures of oils, and glycols, among others. One preferred diluent is paraffinic oil.

In a further embodiment, the formulations contain a rheological additive. In a preferred embodiment, the formulations contain from about 0.5 to about 2.5% w/w of a rheological additive. In a more preferred embodiment, the formulations contain from about 1 to about 2% w/w of a rheological additive. In an even more preferred embodiment, the formulations contain from about 1.2 to about 1.8% w/w of a rheological additive.

Suitable rheological additives include organophillic hectorite clay, modified montmorillonite clay, modified bentonite clay, and castor oil derivatives (hydrogenated and/or organically modified) among others. One preferred rheological additive is modified montmorillonite clay.

In yet another embodiment, the formulations contain at least one emulsifier. In a preferred embodiment, the formulations contain from about 2 to about 9% w/w of at least one emulsifier. In a more preferred embodiment, the formulations contain from about 4 to about 7% w/w of at least one emulsifier. In an even more preferred embodiment, the formulations contain from about 5 to about 6% w/w of at least one emulsifier.

Suitable emulsifiers include non-ionic, anionic, cationic, amphoteric, and other polymeric surfactants or their mixtures. Preferably, the emulsifier is non-ionic because it is easily soluble in the preferred diluent, helps in stabilizing suspension, easily forms stable emulsions, and is not phytotoxic to crops. Preferred emulsifiers include polyol fatty acid esters and polyethoxylated derivatives thereof and polysorbate 20.

In another embodiment, from 35 to about 50% w/w of the total fermentation solids, spores and insecticidal toxins is Bacillus thuringiensis subsp. aizawai fermentation solids, spores and insecticidal toxins. In a preferred embodiment, from 38 to about 42% w/w of the total fermentation solids, spores and insecticidal toxins is Bacillus thuringiensis subsp. aizawai fermentation solids, spores and insecticidal toxins.

In a further embodiment, from 55 to about 65% w/w of the total fermentation solids, spores and insecticidal toxins is Bacillus thuringiensis subsp. kurstaki fermentation solids, spores and insecticidal toxins. In a preferred embodiment, from 58 to about 62% w/w of the total fermentation solids, spores and insecticidal toxins is Bacillus thuringiensis subsp. kurstaki fermentation solids, spores and insecticidal toxins.

In another embodiment, the present invention is directed to methods for controlling Lepidopteran larvae comprising applying the formulations of the present invention to a crop plant. The formulation is preferably suitable for applying either diluted with water or oils. The formulation of the present invention may also be applied either alone or in combination with commonly used pesticides such as chlorantraniliprole, cyantraniliprole, and spinosad (a mixture of Syinosyn A and Sypinosyn D).

In a preferred embodiment, about 5 to about 600 grams of combined Bacillus thuringiensis subsp. kurstaki and Bacillus thuringiensis subsp. aizawai fermentation solids, spores and insecticidal toxins is applied per hectare. In a more preferred embodiment, from about 10 to about 350 grams of combined Bacillus thuringiensis subsp. kurstaki and Bacillus thuringiensis subsp. aizawai fermentation solids, spores and insecticidal toxins is applied per hectare. In a most preferred embodiment, from about 25 to about 300 grams of combined Bacillus thuringiensis subsp. kurstaki and Bacillus thuringiensis subsp. aizawai fermentation solids, spores and insecticidal toxins is applied per hectare.

Although in some embodiments, the rates of Bacillus thuringiensis subsp. aizawai and Bacillus thuringiensis subsp. kurstaki are expressed in grams/hectare, IU/mg, DBMU/mg or Spodoptera U/mg, the invention is not limited to these methods of measuring potency. If other products are developed or marketed with other potency measurements, it is within the knowledge of one of skill in the art, based on Applicant's teaching herein, to convert the rates to effective amounts consistent with the invention herein to achieve synergistic control of the target crop plant pest.

Further, the present invention is not limited to a specific type of formulation. For example, in the examples herein, an emulsifiable suspension was used as the source of Bacillus thuringiensis kurstaki/Bacillus thuringiensis aizawai. However, other types of formulations may be used, including but not limited to, wettable powder formulations, water dispersible granules, dry flowable granules, and other delivery systems.

Suitable Bacillus thuringiensis subsp. aizawai subspecies strains include, but are not limited to, VBTS-1857, GB413, GC-91, and recombinant, transconjugate and modified strains.

The formulations of the present invention may be used to control many different crop pests. The chart below lists several target crop pests suitable for controlling with the formulations of the present invention.

| Common name | Scientific name |
|---|---|
| Achema Sphinx Moth (Hornworm) | Eumorpha achemon |
| Alfalfa Caterpillar | Colias eurytheme |
| Almond Moth | Caudra cautella |
| Amorbia Moth | Amorbia humerosana |
| Armyworm | Spodoptera spp., e.g. exigua, |
| | frugiperda, littoralis, Pseudaletia |
| | unipuncta |
| Artichoke plume moth | Platyptilia carduidactyla |
| Azalea Caterpillar | Datana major |
| Bagworm | Thyridopteryx ephemeraeformis |
| Banana Moth | Hypercompe scribonia |
| Banana Skipper | Erionota thrax |
| Blackheaded Budworm | Acleris gloverana |
| Blossom Worm | Epiglae apiata |
| California Oakworm | Phryganidia californica |
| Cankerworm | Paleacrita merriccata |
| Cherry Fruitworm | Grapholita packardi |
| China Mark Moth | Nymphula stagnata |
| Citrus Cutworm | Xylomyges curialis |
| Codling Moth | Cydia pomonella |
| Cotton Bollworm | Helicoverpa zea |
| Cranberry Fruitworm | Acrobasis vaccinii |
| Cross-striped Cabbageworm | Evergestis rimosalis |
| Cutworm | Various Noctuid species, e.g. |
| | Agrotis ipsilon |
| Diamondback Moth | Plutella xylostella |
| Douglas Fir Tussock Moth | Orgyia pseudotsugata |
| Ello Moth (Hornworm) | Erinnyis ello |
| Elm Spanworm | Ennomos subsignaria |
| European Corn Borer | Ostrinia nubilalis |
| European Grapevine Moth | Lobesia botrana |
| European Skipper (Essex Skipper) | Thymelicus lineola |
| Fall Webworm | Melissopus latiferreanus |
| Filbert Leafroller | Archips rosanus |
| Fireworm | Rhopobota naevana |
| Fruittree Leafroller | Archips argyrospilia |
| Grape Berry Moth | Paralobesia viteana |
| Grape Leafroller | Platynota stultana |
| Grapeleaf Skeletonizer (ground only) | Harrisina americana |
| Grass Looper | Mocus latipes |
| Green Cloverworm | Plathypena scabra |
| Greenstriped Mapleworm | Dryocampa rubicunda |
| Gypsy Moth | Lymantria dispar |
| Hagmoth | Phobetron pithecium |
| Headworm | Helicoverpa zea |
| Hemlock Looper | Lambdina fiscellaria |
| Hornworm | Manduca spp. |
| Imported Cabbageworm | Pieris rapae |
| Indian Meal Moth | Plodia interpunctella |
| To Moth | Automeris io |
| Jack Pine Budworm | Choristoneura pinus |
| Light brown apple moth | Epiphyas postvittana |
| Looper | Various Noctuidae, e.g. |
| | Trichoplusia ni |
| Melonworm | Diaphania hyalinata |
| Mimosa Webworm | Homadaula anisocentra |
| Obliquebanded Leafroller | Choristoneura rosaceana |
| Oleander Moth | Syntomeida epilais |
| Omnivorous Leafroller | Playnota stultana |
| Omnivorous Looper | Sabulodes aegrotata |
| Orangedog | Papilio cresphontes |
| Orange Tortrix | Argyrotaenia citrana |
| Oriental Fruit Moth | Grapholita molesta |
| Owleye Moth | Anthera polyphemus |
| Peach twig borer | Anarsia lineatella |
| Pecan Nut Casebearer | Acrobasis nuxvorella |
| Pine Butterfly | Neophasia menapia |
| Podworm | Heliocoverpa zea |
| Range Caterpillar | Hemileuca oliviae |
| Redbanded Leafroller | Argyrotaenia velutinana |
| Redhumped Caterpillar | Schizura concinna |
| Rindworm complex | Various leps. |
| Saddleback Caterpillar | Sibine stimulea |
| Saddle Prominent Caterpillar | Heterocampa guttivitta |
| Saltmarsh Caterpillar | Estigmene acrea |
| Sod Webworm | Crambus spp. |
| Soybean Looper | Pseudoplusia includens |
| Spanworm | Ennomos subsignaria |
| Sparganothis Fruitworm | Sparganothis sulfureana |
| Spring and Fall Cankerworm | Paleacrita vernata and Alsophila |
| | pometaria |
| Spruce budworm | Choristoneura fumiferana |
| Tent Caterpillar | Various Lasiocampidae |
| Thecla-Thecla Basilides (Geyr) | Thecla basilides |
| Tobacco Budworm | Heliothis virescens |
| Tobacco Hornworm | Manduca sexta |
| Tobacco Moth | Ephestia elutella |
| Tomato Fruitworm | Helicoverpa zea |
| Tufted Apple Budmoth | Platynota idaeusalis |
| Twig Borer | Anarsia lineatella |
| Vaquita | Oisphanes sp. |
| Variegated Cutworm | Peridroma saucia |
| Variegated Leafroller | Platynota flavedana |
| Velvetbean Caterpillar | Anticarsia gemmatalis |
| Walnut Caterpillar | Datana integerrima |
| Webworm | Hyphantria cunea |
| Western Tussock Moth | Orgyia vetusta |
| Southern cornstalk borer | Diatraea crambidoides |
| Sugarcane borer | Diatraea saccharalis |
| Corn earworm, cotton bollworm, | Helicoverpa zea |
| tomato fruitworm | |
| Tobacco budworm | Heliothis virescens |

In a further embodiment, the present invention is directed to methods for controlling a crop plant pest comprising applying formulations of the present invention to a crop plant wherein the crop plant is selected from the group consisting of root and tuber vegetables, bulb vegetables, leafy non-brassica vegetables, leafy brassica vegetables, succulent or dried legumes, fruiting vegetables, cucurbit vegetables, citrus fruits, pome fruits, stone fruits, berry and small fruits, tree nuts, cereal grains, forage and fodder grasses and hay, non-grass animal feeds, herbs, spices, flowers, bedding plants, ornamental flowers, artichoke, asparagus, coffee, cotton, tropical/subtropical fruit crops, hops, malanga, peanut, pomegranate, oil seed crops, trees and shrubs, sugarcane, tobacco, turf, and watercress.

In another embodiment, the crop plant is genetically modified. A “genetically modified” crop plant is one that has had specific genes removed, modified or additional gene copies of native or foreign DNA. The change in the crop plant's DNA may result in changes in the type or amount of RNA, proteins and/or other molecules that the crop plant produces which may affect its response to abiotic (e.g. herbicide) or biotic (e.g. insects) stresses, and/or affect its growth, development, or yield.

In a preferred embodiment, the root and tuber vegetables are selected from the group consisting of arracacha, arrowroot, Chinese artichoke, Jerusalem artichoke, garden beet, sugar beet, edible burdock, edible canna, carrot, bitter cassava, sweet cassava, celeriac, root chayote, turnip-rooted chervil, chicory, chufa, dasheen (taro), ginger, ginseng, horseradish, leren, turnip-rooted parsley, parsnip, potato, radish, oriental radish, rutabaga, salsify, black salsify, Spanish salsify, skirret, sweet potato, tanier, turmeric, turnip, yam bean, true yam, and cultivars, varieties and hybrids thereof.

In another preferred embodiment, the bulb vegetables are selected from the group consisting of fresh chive leaves, fresh Chinese chive leaves, bulb daylily, elegans Hosta, bulb fritillaria, fritillaria leaves, bulb garlic, great-headed bulb garlic, serpent bulb garlic, kurrat, lady's leek, leek, wild leek, bulb lily, Beltsville bunching onion, bulb onion, Chinese bulb onion, fresh onion, green onion, macrostem onion, pearl onion, potato bulb onion, potato bulb, tree onion tops, Welsh onion tops, bulb shallot, fresh shallot leaves, and cultivars, varieties and hybrids thereof.

In a further embodiment, the leafy non-brassica vegetables are selected from the group consisting of Chinese spinach Amaranth, leafy Amaranth, arugula (roquette), cardoon, celery, Chinese celery, celtuce, chervil, edible-leaved chrysanthemum, garland chrysanthemum, corn salad, garden cress, upland cress, dandelion, dandelion leaves, sorrels (dock), endive (escarole), Florence fennel, head lettuce, leaf lettuce, orach, parsley, garden purslane, winter purslane, radicchio (red chicory), rhubarb, spinach, New Zealand spinach, vine spinach, Swiss chard, Tampala, and cultivars, varieties and hybrids thereof.

In another embodiment, the leafy brassica vegetables are selected from the group consisting of broccoli, Chinese broccoli (gai lon), broccoli raab (rapini), Brussels sprouts, cabbage, Chinese cabbage (bok choy), Chinese napa cabbage, Chinese mustard cabbage (gai choy), cauliflower, cavalo broccoli, collards, kale, kohlrabi, mizuna, mustard greens, mustard spinach, rape greens, and cultivars, varieties and hybrids thereof.

In yet another embodiment, the succulent or dried vegetable legumes are selected from the group consisting of Lupinus beans, Phaseolus beans, Vigna beans, broad beans (fava), chickpea (garbanzo), guar, jackbean, lablab bean, lentil, Pisum peas, pigeon pea, soybean, immature seed soybean, sword bean, peanut, and cultivars, varieties and hybrids thereof. In a preferred embodiment, the Lupinus beans include grain lupin, sweet lupin, white lupin, white sweet lupin, and hybrids thereof. In another preferred embodiment, the Phaseolus beans include field bean, kidney bean, lima bean, navy bean, pinto bean, runner bean, snap bean, tepary bean, wax bean, and hybrids thereof. In yet another preferred embodiment, the Vigna beans include adzuki bean, asparagus bean, blackeyed bean, catjang, Chinese longbean, cowpea, Crowder pea, moth bean, mung bean, rice bean, southern pea, urid bean, yardlong bean, and hybrids thereof. In another embodiment, the Pisum peas include dwarf pea, edible-podded pea, English pea, field pea, garden pea, green pea, snow pea, sugar snap pea, and cultivars, varieties and hybrids thereof.

In a further embodiment, the fruiting vegetables are selected from the group consisting of bush tomato, cocona, currant tomato, garden huckleberry, goji berry, groundcherry, martynia, naranjilla, okra, pea eggplant, pepino, peppers, non-bell peppers, roselle, Scout tomato fields roselle, eggplant, scarlet eggplant, African eggplant, sunberry, tomatillo, tomato, tree tomato, and cultivars, varieties and hybrids thereof. In a preferred embodiment, the peppers include bell peppers, chili pepper, cooking pepper, pimento, sweet peppers, and cultivars, varieties and hybrids thereof.

In an embodiment, the cucurbit vegetables are selected from the group consisting of Chayote, Chayote fruit, waxgourd (Chinese preserving melon), citron melon, cucumber, gherkin, edible gourds, Momordica species, muskmelons, pumpkins, summer squashes, winter squashes, watermelon, and cultivars, varieties and hybrids thereof. In a preferred embodiment, edible gourds include hyotan, cucuzza, hechima, Chinese okra, and hybrids thereof. In another preferred embodiment, the Momordica vegetables include balsam apple, balsam pear, bittermelon, Chinese cucumber, and hybrids thereof. In another preferred embodiment, the muskmelon include true cantaloupe, cantaloupe, casaba, crenshaw melon, golden pershaw melon, honeydew melon, honey balls, mango melon, Persian melon, pineapple melon, Santa Claus melon, snake melon, and hybrids thereof. In yet another preferred embodiment, the summer squash include crookneck squash, scallop squash, straightneck squash, vegetable marrow, zucchini, and hybrids thereof. In a further preferred embodiment, the winter squash includes butternut squash, calabaza, hubbard squash, acorn squash, spaghetti squash, and cultivars, varieties and hybrids thereof.

In another embodiment, the citrus fruits are selected from the group consisting of limes, calamondin, citron, grapefruit, Japanese summer grapefruit, kumquat, lemons, Mediterranean mandarin, sour orange, sweet orange, pummel, Satsuma mandarin, tachibana orange, tangelo, mandarin tangerine, tangor, trifoliate orange, uniq fruit, and cultivars, varieties and hybrids thereof. In a preferred embodiment, the limes are selected from the group consisting of Australian desert lime, Australian finger lime, Australian round lime, Brown River finger lime, mount white lime, New Guinea wild lime, sweet lime, Russell River lime, Tahiti lime, and hybrids thereof.

In an embodiment, the pome fruits are selected from the group consisting of apple, azarole, crabapple, loquat, mayhaw, medlar, pear, Asian pear, quince, Chinese quince, Japanese quince, tejocote, and cultivars, varieties and hybrids thereof.

In another embodiment, the stone fruits are selected from the group consisting of apricot, sweet cherry, tart cherry, nectarine, peach, plum, Chicksaw plum, Damson plum, Japanese plum, plumcot, fresh prune, and cultivars, varieties and hybrids thereof.

In a further embodiment, the berries and small fruits are selected from the group consisting of Amur river grape, aronia berry, bayberry, bearberry, bilberry, blackberry, blueberry, lowbush blueberry, highbush blueberry, buffalo currant, buffaloberry, che, Chilean guava, chokecherry, cloudberry, cranberry, highbush cranberry, black currant, red currant, elderberry, European barberry, gooseberry, grape, edible honeysuckle, huckleberry, jostaberry, Juneberry (Saskatoon berry), lingonberry, maypop, mountain pepper berries, mulberry, muntries, native currant, partridgeberry, phalsa, pincherry, black raspberry, red raspberry, riberry, salal, schisandra berry, sea buckthorn, serviceberry, strawberry, wild raspberry, and cultivars, varieties and hybrids thereof. In a preferred embodiment, the blackberries include Andean blackberry, arctic blackberry, bingleberry, black satin berry, boysenberry, brombeere, California blackberry, Chesterberry, Cherokee blackberry, Cheyenne blackberry, common blackberry, coryberry, darrowberry, dewberry, Dirksen thornless berry, evergreen blackberry, Himalayaberry, hullberry, lavacaberry, loganberry, lowberry, Lucreliaberry, mammoth blackberry, marionberry, mora, mures deronce, nectarberry, Northern dewberry, olallieberry, Oregon evergreen berry, phenomenalberry, rangeberry, ravenberry, rossberry, Shawnee blackberry, Southern dewberry, tayberry, youngberry, zarzamora, and hybrids thereof.

In another embodiment, the tree nuts are selected from the group consisting of almond, beech nut, Brazil nut, butternut, cashew, chestnut, chinquapin, hazelnut (filbert), hickory nut, macadamia nut, pecan, pistachio, black walnut, English walnut, and cultivars, varieties and hybrids thereof.

In a further embodiment, the cereal grains are selected from the group consisting of barley, buckwheat, pearl millet, proso millet, oats, corn, field corn, sweet corn, seed corn, popcorn, rice, rye, sorghum (milo), sorghum species, grain sorghum, Sudangrass (seed), teosinte, triticale, wheat, wild rice, and cultivars, varieties and hybrids thereof.

In yet another embodiment, the grass forage, fodder and hay are selected from the group consisting of grasses that are members of the Gramineae family except sugarcane and those species included in the cereal grains group, pasture and range grasses, and grasses grown for hay or silage. In further embodiments, the Gramineae grasses may be green or cured.

In an embodiment, the non-grass animal feeds are selected from the group consisting of alfalfa, velvet bean, trifolium clover, melilotus clover, kudzu, lespedeza, lupin, sainfoin, trefoil, vetch, crown vetch, milk vetch, and cultivars, varieties and hybrids thereof.

In another embodiment, the herbs and spices are selected from the group consisting of allspice, angelica, anise, anise seed, star anise, annatto seed, balm, basil, borage, burnet, chamomile, caper buds, caraway, black caraway, cardamom, cassia bark, cassia buds, catnip, celery seed, chervil, chive, Chinese chive, cinnamon, clary, clove buds, coriander leaf, coriander seed, costmary, culantro leaves, culantro seed, cilantro leaves, cilantro seed, cumin, dillweed, dill seed, fennel, common fennel, Florence fennel seed, fenugreek, grains of paradise, horehound, hyssop, juniper berry, lavender, lemongrass, leaf lovage, seed lovage, mace, marigold, marjoram, mint, mustard seed, nasturtium, nutmeg, parsley, pennyroyal, black pepper, white pepper, poppy seed, rosemary, rue, saffron, sage, summer savory, winter savory, sweet bay, tansy, tarragon, thyme, vanilla, wintergreen, woodruff, wormwood, and cultivars, varieties and hybrids thereof. In a preferred embodiment, the mints are selected from the group consisting of spearmint, peppermint, and hybrids thereof.

In yet another embodiment, artichokes are selected from the group consisting of Chinese artichoke, Jerusalem artichoke, and cultivars, varieties and hybrids thereof.

In an embodiment, the subtropical/tropical fruits are selected from the group consisting of anonna, avocado, fuzzy kiwifruit, hardy kiwifruit, banana, plantain, caimito, carambola (star fruit), guava, longan, sapodilla, papaya, passion fruit, mango, lychee, jackfruit, dragon fruit, mamey sapote, coconut cherimoya, canistrel, monster, wax jambu, pomegranate, rambutan, pulasan, Pakistani mulberry, langsat, chempedak, durian, fig pineapple, jaboticaba, mountain apples, bananas, guavas, pineapple, and cultivars, varieties and hybrids thereof.

In a further embodiment, the oil seed vegetables are selected from the group consisting of borage, calendula, castor oil plant, tallowtree, cottonseed, crambe, cuphea, echium, euphorbia, evening primrose, flax seed, gold of pleasure, hare's ear, mustard, or oil rapeseed, jojoba, lesquerella, lunaria, meadowfoam, milkweed, niger seed, oil radish, poppy seed, rosehip, sesame, stokes aster, sweet rocket, tallowwood, tea oil plant, vermonia, canola, or oil rapeseed, safflower, sunflower, and cultivars, varieties and hybrids thereof.

In another embodiment, the trees and shrubs are selected from the group consisting of forest trees, shade trees, and sugar maples, and cultivars, varieties and hybrids thereof.

The formulations of the present invention may be applied to seeds, foliage, or an area where a plant is intended to grow.

In an alternative embodiment, the formulations of the present invention are applied to stored agricultural commodities. The stored commodities include, but are not limited to, grains, soybeans, sunflower seeds, crop seeds, condimental seeds, spices, herbs, birdseed, and popcorn.

The formulations of the present invention may be applied undiluted (neat) or diluted with water or oils to a desired concentration prior to application.

The formulations of the present invention may also include other adjuvants. Suitable adjuvants may include preservatives, surface active agents, dispersants, binders, polymers, pH regulators, drift control agents, UV protectants, colorants, microencapsulating agents, sugars, starches, free-flow agents, clays, nutrients, humectants, plant growth regulators or stimulants, feeding stimulants, other natural, naturally derived or synthetic compounds with insecticidal or fungicidal or miticidal properties or systemic acquired resistance (SAR), among others. The choice of a component and its concentration to be chosen may vary depending upon the formulation type, end use dilution, application method (aerial or ground), crop and crop pest complex, tank-mix to be used, stability requirements, cost of treatment among many other requirements.

The formulations may further contain additives, for example, additives for improved rain-fastness, UV protection, improved thermal stability, drift control property, and feeding stimulants.

In yet another embodiment, the formulation of the present invention is applied to crop plants with another agricultural active ingredient. The other active may be for example, a fungicide, an insecticide, miticide, a plant growth regulator or a plant growth stimulant

In a preferred embodiment, the formulation of the present invention is applied to crop plants with at least one anthranilic diamide insecticide. Preferred anthranilic diamides are chlorantraniliprole and flubendiamide.

Chlorantraniliprole is an anthranilic diamide. Chlorantraniliprole has low toxicity to humans and mammals. Further, it is effective at low use rates. Like Bacillus thuringiensis, chlorantraniliprole must be eaten by larvae in order to be effective. Chlorantraniliprole forces muscles within the larvae to release all of their stored calcium, causing the larvae to stop eating and eventually die.

In another embodiment, the formulation of the present invention is applied to crop plants with an ovicide. In a preferred embodiment, the ovicide is thiacarb.

The additional active ingredients may be formulated with the Bacillus thuringiensis subsp. kurstaki and Bacillus thuringiensis subsp. aizawai fermentation solids, spores and insecticidal toxins. The additional active ingredients may also be tank-mixed with the formulations of the present invention. Alternatively, the additional active ingredients may be applied separately but at the same time as the formulations or in rotation with the application of the present invention.

In a preferred embodiment, the formulations of the present invention are applied when the larvae are young (early instars) and actively feeding and more importantly before economic thresholds of damage have been exceeded.

In yet another embodiment, the formulations of the present invention are applied to the crop plants at least one time per season. In preferred embodiment, the formulations are applied one to seven times per season depending upon pest pressure, crop growth, and environmental conditions such as rain-fall immediately following application. In a more preferred embodiment, the formulations are applied about three times per season. The formulations of the present invention may be applied by ground, aerial equipment or sprinkler irrigation with quantities of water or other carriers sufficient to provide thorough coverage of infested plant parts.

Regardless of the number of applications per season, the total rate should not exceed a yearly maximum rate as determined by environmental protection agencies or relevant label rates.

In a further embodiment, the present invention is directed to methods for producing the formulations of the present invention. The method includes separately fermenting a high potency strain of Bacillus thuringiensis subsp. kurstaki and a Bacillus thuringiensis subsp. aizawai strain under optimized growth media and growth conditions preserving and combining the fermentation slurries at specific ratio of either potency or solids containing Bacillus thuringiensis crystal toxins, spores, synergistic metabolites and vegetative insecticidal proteins, spray-drying the combined fermentation slurry to yield technical grade active ingredient, processing, characterizing for physical and biological properties and formulating it into various product forms preferred among which are emulsifiable suspension concentrate and water dispersible granule. The combined slurry may also be directly formulated with dispersants, stabilizers, surfactants, and diluents and spray dry granulated in a semi-continuous or fluid bed granulator to yield dry flowable or wettable granular formulation. In an alternative embodiment, the fermentation beers can be concentrated by methods known by those of skilled in the art as for example by centrifugation, evaporation, microfiltration or ultrafiltration or by combination of two or more recovery methods.

As used herein, “plant” refers to at least one plant and not a plant population.

As used herein, when referring to the ratio of Bacillus thuringiensis subsp. kurstaki to Bacillus thuringiensis aizawai, the ratio includes the wt % of fermentation solids, spores and insecticidal toxins of Bacillus thuringiensis subsp. kurstaki compared to the wt % of fermentation solids, spores and insecticidal toxins of Bacillus thuringiensis aizawai.

As used herein, “control” or “controlling” means a decline in the amount of damage to the plants from the larvae, reduction of pest population, interference with life cycle development or other physiological or behavioral effect that results in plant protection.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

The disclosed embodiments are simply exemplary embodiments of the inventive concepts disclosed herein and should not be considered as limiting, unless so stated.

The following examples are intended to illustrate the present invention and to teach one of ordinary skill in the art how to make and use the invention. They are not intended to be limiting in any way.

### EXAMPLES

Bacillus thuringiensis kurstaki, strain VBTS-2546 was used as the source of Bacillus thuringiensis subsp. kurstaki in the following examples.

Bacillus thuringiensis aizawai, strain ABTS-1857 (available from Valent BioSciences Corporation), was used as the source of Bacillus thuringiensis subsp. aizawai in the following examples.

Sunspray 6N (available from R.E. Carroll, Inc and others) paraffinic agricultural spray oil, a light paraffinic petroleum distillate, was used as the source of the diluent in the following examples.

Bentone® 38 (available from Elementis Specialties, Inc., Bentone is a registered trademark of Elementis Specialties, Inc.) montmorillonite clay, a modified rheological additive, was used as the source of the rheological additive in the following examples.

Atplus™ 300 FA (available from Croda Crop Care) emulsifier, comprised of a polyol fatty acid esters and polyethoxylated derivatives thereof, was used as a source of the emulsifier in the following examples.

Polysorbate 20 or Tween 20 (available from Croda Crop Care) surfactant was used as a source of the emulsifier in the following examples.

### Example 1

The formulations of the present invention were prepared as follows. Bacillus thuringiensis subsp. kurstaki and Bacillus thuringiensis subsp. aizawai were separately fermented. The fermentation slurries were then combined in a mix-tank at the desired fermentation solids ratio, 60:40 of Bacillus thuringiensis subsp. kurstaki to Bacillus thuringiensis aizawai. Next, the slurry was spray-dried and sieved to obtain technical grade active ingredient.

In a tank with a mixer, a gel concentrate was prepared using a portion of the diluent, rheological additive, and emulsifier. In a separate tank with a mixer, the diluent paraffinic agricultural spray oil was first charged, followed by the gel concentrate, the active ingredient, and then the remaining emulsifier(s). The formulation was mixed until homogeneous. The formulation was then sieved to remove particles above about 100 micrometers diameter. An example of this formulation is below in Table 1. The amount of diluent, rheological additives, and emulsifiers will vary depending upon the concentration of Bacillus thuringiensis subsp. kurstaki and Bacillus thuringiensis aizawai, which will vary depending on the potency of the fermentation slurry.

TABLE 1
Emulsifiable Suspension Concentrate Formulation

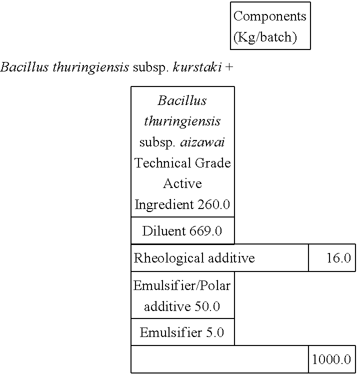

### Example 2

### Potency of the Formulations

Six additional batches of the Formulation of the present invention were prepared with amounts of Bacillus thuringiensis subsp. kurstaki and Bacillus thuringiensis subsp. aizawai that varied from about 25% to about 28% wt/wt. These formulations were then tested for potencies and LC₅₀ values for cabbage looper, diamondback moth, and beet armyworm. The results of these studies are summarized below in Tables 2, 3 and 4.

TABLE 2
Formulation Cabbage Looper Potencies and LC₅₀ Values

| | | | | LC₅₀ |
|---|---|---|---|---|
| | % Btk + Bta | Potency | | Cabbage Looper |
| Formulation | (0.6:0.4 ratio) | (IU/mg) | S.D. | ug/mL |
| 2A | 26.5 | 18,385 | 943 | 30.3 |
| 2B | 26.5 | 17,592 | 163 | 31.6 |
| 2C | 26.5 | 18,658 | 1198 | 30.0 |
| 2D | 27.0 | 19,561 | 627 | 28.5 |
| 2E | 28.0 | 19,538 | 3167 | 29.0 |
| 2F | 25.0 | 18,627 | 2058 | 30.1 |
| Mean | 26.58 | 18,727 | | 29.9 |

TABLE 3
Formulation Diamondback Moth Potencies and LC₅₀ Values

| | % Btk + Bta | LC₅₀ | 95% CL | Potency |
|---|---|---|---|---|
| Formulation | ( 0.6:0.4 ratio) | ug/mL | (ug/ml) | DBMU/mg |
| 2A | 26.5 | 1.59 | 1.02-2.17 | 47803 |
| 2B | 26.5 | 2.00 | 1.39-2.80 | 38003 |
| 2C | 26.5 | 1.87 | 1.52-2.29 | 40645 |
| 2D | 27.0 | 1.62 | 1.19-2.07 | 46917 |
| 2E | 28.0 | 1.81 | 1.50-2.11 | 41992 |
| 2F | 25.0 | 1.45 | 1.00-1.85 | 52418 |
| Mean | 26.58 | 1.72 | | 44630 |

Note:
Bta Ref. Std: LC₅₀ = 1.25 ug/mL (CL = 0.922-1.56); Potency =
60,805 DBM U/mg.
Formulation Beet Armyworm LC₅₀ Values

| | % Btk + Bta | LC₅₀ | 95% CL |
|---|---|---|---|
| Formulation | ((0.60:0.4 ratio) | ug/mL | (ug/ml) |
| 2A | 26.5 | 169 | 143-202 |
| 2B | 26.5 | 196 | 175-221 |
| 2C | 26.5 | 197 | 158-251 |
| 2D | 27.0 | 169 | 124-239 |
| 2E | 28.0 | 147 | 131-265 |
| 2F | 25.0 | 182 | 161-206 |
| Mean | 26.58 | 177 | |

Note:
Bta Ref. Std: LC₅₀ = 27.8 ug/mL (CL = 24.6-31.4)

As seen in Table 3, the formulations of the present invention have potencies as determined against standard cabbage looper of more than 17,590 IU/mg. The LC₅₀ rates for cabbage looper, beet armyworm and diamondback moth all show that the synergistic weight ratio of 0.6:0.4 Bacillus thuringiensis kurstaki:Bacillus thuringiensis subsp. aizawai as formulated by Applicant produces high kill rates for all three pests. These results were unexpected because other ratios of Bacillus thuringiensis kurstaki:Bacillus thuringiensis subsp. aizawai failed to provide superior results.

### Example 3

### Toxin Content of the Formulations

The formulations of the present invention were analyzed using ion exchange HPLC using standard techniques known by those of skill in the art (see for reference U.S. Pat. No. 5,523,211). To summarize, the parasporal crystals of Bacillus thuringiensis were solubilized, separated and quantified to determine the levels of the toxins Cry1Aa, Cry1Ab, Cry1Ac, Cry1C, and Cry1D that are present in formulations of the present invention. As seen in Table 4 below, the study showed clear toxin peaks for Cry1Aa, Cry1Ab, Cry1Ac, Cry1C, and Cry1D.

TABLE 4
Ion-Exchange HPLC analysis the Formulations

| | | | | | | Total P1 |
|---|---|---|---|---|---|---|
| Sample | Cry1C | Cry1D | Cry1Aa | Cry1Ab | Cry1Ac | toxins |
| Btk | — | — | 1408915 | 1935756 | 927755 | 4,272,426 |
| STD | | | (32.97) | (45.31) | (21.72) | |
| Bta | 1990546 | 149093 | 919525 | 2006976 | — | 5,066,140 |
| STD | (39.29) | (2.94) | (18.15) | (39.62) | | |
| Form. of | 479077 | 130040 | 442808 | 1107617 | 545870 | 2,705,412 |
| Ex. 1 | (17.71) | (4.81) | (16.37) | (40.93) | (20.18) | |

As confirmed by this study, Bacillus thuringiensis subsp. kurstaki expresses toxins Cry1Aa, Cry1Ab, and Cry1Ac. Bacillus thuringiensis subsp. aizawai expresses toxins Cry1C, Cry1D, Cry1Aa, and Cry1Ab. As seen in Table 4, the formulations of the present invention contain toxins expressed by Bacillus thuringiensis subsp. kurstaki and Bacillus thuringiensis aizawai.

### Example 4

### Tank-Mixes

As indicated above, formulations of the present invention may be mixed with other active ingredients in a tank-mix or formulated with other actives. Table 5 illustrates some of these suggested tank-mixes. The present invention is not limited to these examples.

TABLE 5
Example Btk/Bta (60:40) Tank-Mixes 1.2 to 4.7 Liters

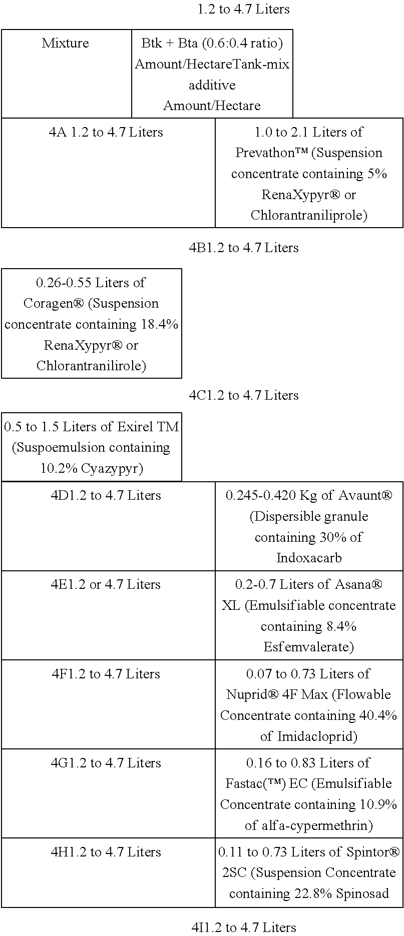

0.11 to 0.29 Liters of Belt ® SC (Suspension Concentrate containing 39% Flubendiamide) (available from Bayer)

### Example 5

A study was conducted to determine the effect that a synergistic weight ratio of Bacillus thuringiensis subsp. kurstaki and Bacillus thuringiensis subsp. aizawai would have on insect species with known resistance to the commonly used insecticide, chlorantraniliprole. Prevathon™ (available from DuPont™) is a 5% suspension concentrate of chlorantraniliprole and was used as the source of chlorantraniliprole in the following two studies. Sympatico™ emulsifiable suspension concentrate (available from Valent BioSciences Corporation) was used as the source of Bacillus thuringiensis subsp. aizawai and Bacillus thuringiensis kurstaki. Sympatico™ contains about a 60:40 weight ratio of Bacillus thuringiensis subsp. kurstaki fermentation solids, spores and toxins to Bacillus thuringiensis subsp. aizawai fermentation solids, spores and toxins. The plots were planted with cabbage and naturally infested with populations of diamondback moth (Plutella xylostella) and cabbage cluster caterpillar (Crocidolomia pavonana) that were known to be resistant to chlorantraniliprole.

TABLE 6

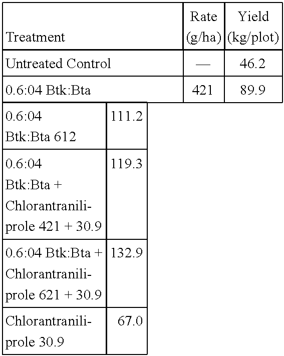

As seen in Table 6, the synergistic weight ratio of Bacillus thuringiensis subsp. kurstaki to Bacillus thuringiensis subsp. aizawai provided significant yield gains. While the untreated control and chlorantraniliprole treated plots had yields of only 46.2 and 67.0 kg/plot, respectively, the Bacillus thuringiensis kurstaki/Bacillus thuringiensis subsp. aizawai treated plots had yields of at least 89.9 kg/plot. This study confirmed that Bacillus thuringiensis kurstaki/Bacillus thuringiensis subsp. aizawai synergistic mixtures are effective at controlling larvae that have developed resistance to chlorantraniliprole.

### Example 7

Another study was conducted to determine the effect that a synergistic weight ratio of Bacillus thuringiensis subsp. kurstaki and Bacillus thuringiensis subsp. aizawai would have on insect species with known resistance to the commonly used insecticide, chlorantraniliprole.

TABLE 7

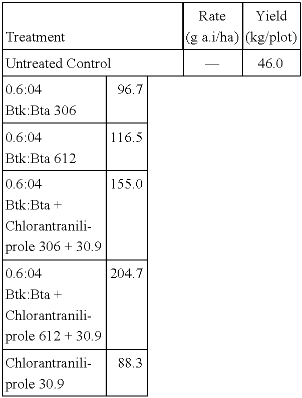

As seen in Table 7, the synergistic weight ratio of Bacillus thuringiensis subsp. kurstaki to Bacillus thuringiensis subsp. aizawai provided significant yield gains. Further, mixtures of the formulations of the present invention with chlorantraniliprole were especially effective at increasing yields.

1. An agricultural formulation comprising:
from about 10 to about 40% w/w of Bacillus thuringiensis fermentation solids, spores and insecticidal toxins; and
from about 60 to about 90% w/w of a diluent;
wherein the fermentation solids, spores and insecticidal toxins are derived from a high potency Bacillus thuringiensis subsp. kurstaki strain and a Bacillus thuringiensis subsp. aizawai strain, and the weight ratio of Bacillus thuringiensis subsp. kurstaki fermentation solids, spores and insecticidal toxins to Bacillus thuringiensis subsp. aizawai fermentation solids, spores and insecticidal toxins is from about 20:80 to 80:20.

2. The formulation of claim 1 wherein the high potency Bacillus thuringiensis subsp. kurstaki strain is selected from the group consisting of ABTS-351, VBTS-2528, and VBTS-2546.

3. The formulation of claim 2 wherein the high potency Bacillus thuringiensis subsp. kurstaki strain is VBTS-2546.

4. The formulation of claim 1 wherein the weight ratio of Bacillus thuringiensis subsp. kurstaki fermentation solids, spores and insecticidal toxins to Bacillus thuringiensis subsp. aizawai fermentation solids, spores and insecticidal toxins is from about 30:70 to about 70:30.

5. The formulation of claim 4 wherein the weight ratio of Bacillus thuringiensis subsp. kurstaki fermentation solids, spores and insecticidal toxins to Bacillus thuringiensis subsp. aizawai fermentation solids, spores and insecticidal toxins is from about 55:45 to about 65 to 35.

6. The formulation of claim 1 wherein the total amount of Bacillus thuringiensis fermentation solids, spores and insecticidal toxins is from about 15 to about 35% w/w.

7. The formulation of claim 6 wherein the total amount of Bacillus thuringiensis fermentation solids, spores and insecticidal toxins is from about 20 to about 29% w/w.

8. The formulation of claim 1 further comprising from about 0.5 to about 2.5% w/w of a rheological additive.

9. The formulation of claim 1 further comprising from about 2 to about 9% w/w of an emulsifier.

10. The formulation of claim 1 wherein from 35 to about 50% w/w of the total fermentation solids, spores and insecticidal toxins is Bacillus thuringiensis subsp. aizawai fermentation solids, spores and insecticidal toxins.

11. The formulation of claim 1 wherein from 50 to about 65% w/w of the total fermentation solids, spores and insecticidal toxins is Bacillus thuringiensis subsp. kurstaki fermentation solids, spores and insecticidal toxins.

12. A method of controlling Lepidopteran larvae comprising applying the formulation of claim 1 to a crop plant.

13. The method of claim 12 wherein the crop plant is a GM crop plant.

14. The method of claim 12 wherein from about 5 to about 400 grams of Bacillus thuringiensis subsp. kurstaki and Bacillus thuringiensis subsp. aizawai fermentation solids, spores and insecticidal toxins is applied per hectare.

15. The method of claim 14 wherein from about 10 to about 350 grams of Bacillus thuringiensis subsp. kurstaki and Bacillus thuringiensis subsp. aizawai fermentation solids, spores and insecticidal toxins is applied per hectare.

16. The method of claim 15 wherein from about 25 to about 300 grams of Bacillus thuringiensis subsp. kurstaki and Bacillus thuringiensis subsp. aizawai fermentation solids, spores and insecticidal toxins is applied per hectare.

17. The method of claim 12 further comprising applying an effective amount of chlorantriliprole to the crop plant.

18. The method of claim 12 further comprising applying an effective amount of ovicide to the crop plant.

19. The method of claim 12 wherein the formulation is applied from 1 to 5 times per growing season.
